(19) United States
(12) Patent Application Publication
(10) Pub. No.: US 2015/0183439 A1
(43) Pub. Date: Jul. 2, 2015

(54) SYSTEMS AND METHODS FOR MONITORING AND REPORTING VEHICLE EFFICIENCY

(71) Applicant: Dean K. Jackson, Pittsburgh, PA (US)

(72) Inventor: Dean K. Jackson, Pittsburgh, PA (US)

(73) Assignee: Google Inc., Mountain View, CA (US)

(21) Appl. No.: 13/433,996

(22) Filed: Mar. 29, 2012

(51) Int. Cl. G01M 17/00

(52) U.S. Cl. CPC B60W 40/00

(57) ABSTRACT

Systems and methods of monitoring vehicle sensors to determine and report fuel/energy efficiency are disclosed. The vehicle's route may be calculated by a GPS-enabled head unit or similar device together with appropriate mapping and navigation software. Monitoring fuel/energy efficiency may be achieved by measuring the mileage and fuel/energy use across the route. This information may be transmitted through a mobile network to a central server for use in mapping and navigation programs to provide the most cost effective and/or fuel/energy efficient route. Another implementation would use the fuel efficiency information to calculate estimated fuel/energy efficiency along particular routes using particular vehicles. Additionally, knowing the route traveled and the actual and expected fuel/energy efficiency, the head unit may display a warning of a loss of fuel/energy efficiency as well as a potential cause of the fuel efficiency loss.

### BACKGROUND

1. Statement of the Technical Field

Embodiments include computing systems and methods for determining and reporting vehicle energy efficiency and sensor performance.

2. Description of the Related Art

The uses and applications of computers in vehicles such as automobiles are growing as manufacturers are increasingly including sophisticated diagnostic sensor networks capable of monitoring operational conditions and vehicle components, such as engine conditions, environmental conditions, fuel consumption, mileage, tire pressure, and the like. As mobile communications technology has become more widespread, automotive computing systems are available that also include network based applications incorporating navigation, voice search, media streaming capabilities, and the like.

Systems have been developed that monitor any of the various operational conditions and vehicle components such as those listed above. On board diagnostics (OBD) standards in the automotive industry were made possible with the advent of engine computer systems in the 1980s. In the United States, the OBD-II standard specifies a 16-pin diagnostic connector that allows owners and mechanics to interface with an engine computer and access data from an engine control unit (ECU). Various sensors are also monitored by the ECU.

Diagnostic systems have been developed that utilize the 16-pin OBD-II connector to monitor various vehicle systems. In particular, a number of devices are available on the market that allow a user to read and continuously monitor various sensors and data outputs directly through the diagnostic connector. However, these systems rely solely on the information provided by a single vehicle and do not allow for data aggregation across multiple vehicles.

Additionally, since the 1980s fuel-injection systems have almost entirely displaced all other fuel delivery systems in gasoline and diesel powered internal combustion engines. Fuel injection systems require precise control over the air/fuel ratio under all operational conditions and include an array of sensors that are capable of precise metering of fuel consumption. Non-liquid fueled vehicles, such as electric vehicles, also include sensors for measuring energy consumption. These sensors are also typically connected to the ECU as with other sensor systems.

### SUMMARY

Systems, devices, and methods of monitoring vehicle sensors to determine and report fuel and/or energy efficiency are disclosed. In one aspect, a GPS-equipped communication device having an electronic circuit in communication with a fuel or energy efficiency sensor is employed to measure mileage and fuel or energy use across a route. the route may be determined using GPS. Fuel and/or energy efficiency thus monitored may be transmitted through a mobile network to a central server for use in mapping and navigation programs to provide the most cost effective and/or fuel efficient route.

Another implementation would use the fuel/energy efficiency information to calculate estimated fuel/energy efficiency along particular routes using particular vehicles. Additionally, knowing the route traveled and the actual and expected fuel/energy efficiency, the head unit may display a warning of a loss of fuel/energy efficiency as well as a potential cause of the fuel/energy efficiency loss. For example, the fuel/energy efficiency sensor data and tire pressure sensor data may be combined to calculate an estimated fuel/energy efficiency loss due to underinflated tires. The head unit may then inform the driver of the estimated fuel/energy efficiency loss due to underinflated tires. In implementations, data may be collected continuously or at predetermined intervals.

### BRIEF DESCRIPTION OF THE DRAWINGS

Embodiments will be described with reference to the following drawing figures, in which like numerals represent like items throughout the figures, and in which:

FIG. 1 is a block diagram of an exemplary automotive system.

FIG. 2 is a block diagram of an exemplary automotive system.

FIG. 3 is a block diagram of an exemplary automotive device.

FIG. 4 is a block diagram of an exemplary communication device.

FIG. 5 is a flow diagram of an exemplary method for monitoring and reporting fuel/energy efficiency in a vehicle.

FIG. 6 is a flow diagram of an exemplary method for monitoring and analyzing fuel/energy efficiency in a vehicle.

### DETAILED DESCRIPTION

Example implementations of the present invention are described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention may be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if X employs A; X employs B; or X employs both A and B, then “X employs A or B” is satisfied under any of the foregoing instances.

Examples below discuss systems and methods for advantageously monitoring vehicle sensors to determine and report fuel and/or energy efficiency. The terms “fuel efficiency” and “energy efficiency” are used somewhat interchangeably, as well as use of the term “fuel/energy”. Use of the term “fuel/energy” is intended to indicate that liquid fuel or an alternative energy source is envisioned. Embodiments are intended for use in vehicles which consume a liquid fuel, as well as hybrids and those using an alternative energy sources, such as but not limited to electric vehicles. For example, a communication device which may be incorporated in the vehicle's radio or stereo system, i.e. “head unit,” includes a connection to at least one fuel/energy efficiency sensor and may monitor the sensor(s) continuously or at predetermined intervals may be employed. The vehicle's route may be calculated by a GPS-enabled head unit or similar device together with appropriate mapping and navigation software. Monitoring fuel/energy efficiency may be achieved by measuring the mileage and fuel/energy use across the route. This information may be transmitted through a mobile network to a central server for use in mapping and navigation programs to provide data for determining the most cost effective and/or fuel/energy efficient routes.

In another implementation, the fuel/energy efficiency information may be used to calculate estimated fuel/energy efficiency along particular routes using particular vehicles and the estimated efficiency may be compared to the actual measured efficiency of the user's vehicle to determine if there is a loss of fuel/energy efficiency. For example, knowing the route traveled and the actual and expected fuel/energy efficiency, the head unit may display a warning of a loss of fuel/energy efficiency as well as a potential cause of the fuel/energy efficiency loss. In one implementation, the fuel/energy efficiency sensor data and tire pressure sensor data may be combined to calculate an estimated fuel/energy efficiency loss due to underinflated tires. The head unit may then inform the driver of the estimated fuel/energy efficiency loss due to underinflated tires.

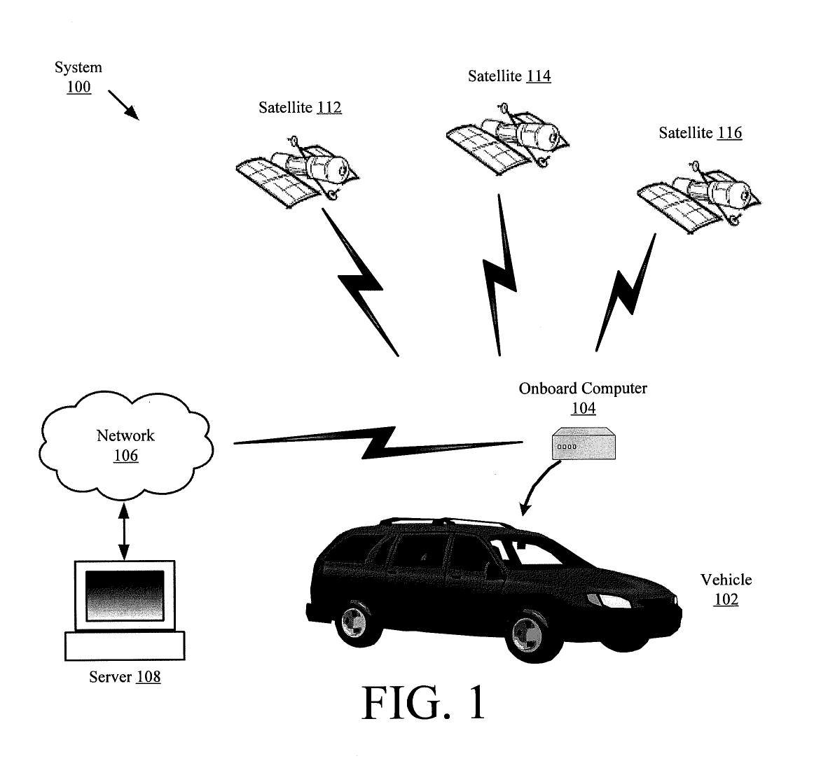

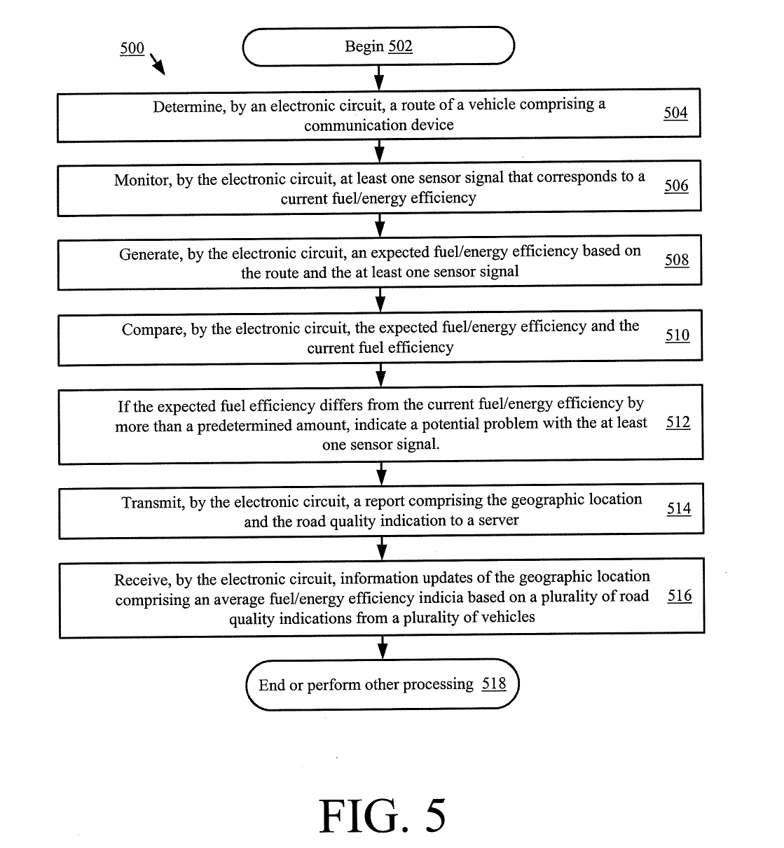

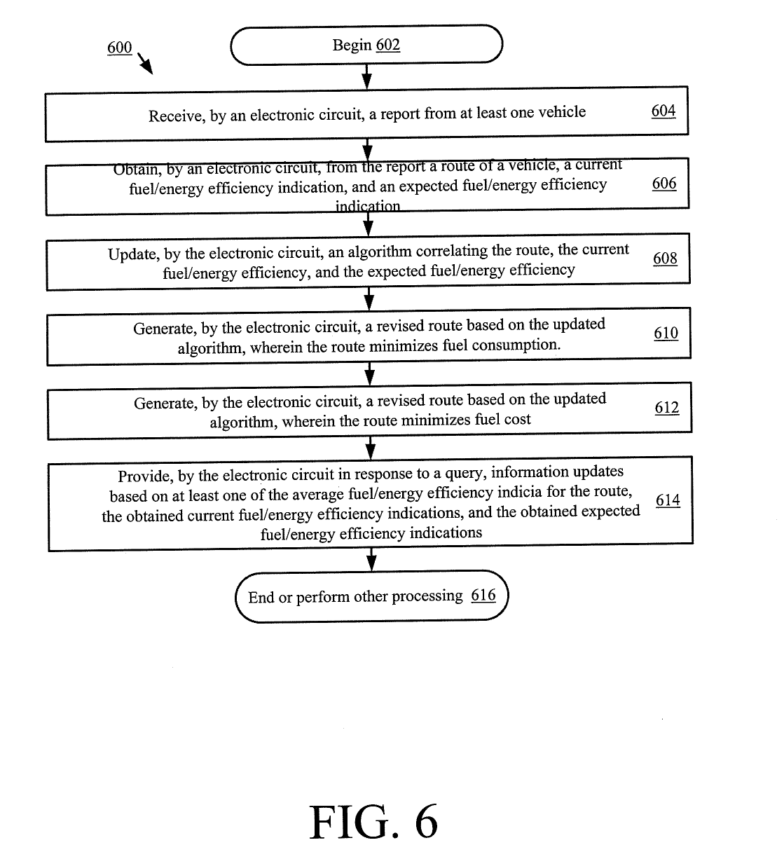

Automotive implementations may employ other devices. Use of the term “onboard computer” or “head unit” herein is intended to also include use of alternative devices unless otherwise indicated. Various implementations of the present invention may use alternative devices and device applications. Exemplary implementing system embodiments of the present invention will be described below in relation to FIGS. 1-4. Exemplary method embodiments of the present invention will be described below in relation to FIGS. 5-6.

### Exemplary Systems

Referring now to FIG. 1, there is provided a block diagram of an exemplary system 100 that comprises a vehicle 102, an onboard computer 104, a network 106, a server 108 and satellites 112-116. The system 100 may include more, less, or different components than those illustrated in FIG. 1. However, the components shown are sufficient to disclose an illustrative embodiment implementing the present invention.

The vehicle 102 is also configured to allow the onboard computer 104 to control and monitor various vehicle sensor systems and networks within the vehicle 102 including, but not limited to, sensors for monitoring vehicle diagnostic systems, environmental conditions within and outside the vehicle, road quality, fuel/energy efficiency, engine tuning and performance, wind speed, and the like.

The onboard computer 104 is also configured to control and monitor various vehicle systems and networks based on information received from the server 108 via network 106. This information may include, but is not limited to, an updated map or navigation route. The updated navigation route is determined by the server 108 based at least on location data (e.g., the GPS data) and/or sensor data obtained by the onboard computer 104. The sensor data includes, but is not limited to, fuel/energy level and use data, distance data, time data, direction data, velocity data, and/or acceleration data.

In an implementation, the vehicle 102 is a GPS enabled vehicle. As such, the vehicle 102 includes a GPS receiver (not shown in FIG. 1) in communication with an onboard computer 104. The GPS receiver is generally configured to receive GPS signals from the satellites 112-116 and process the GPS signals to determine an estimate of the current location of the vehicle 102 on Earth. The current location of the vehicle 102 is determined by computing a difference between a time that each GPS signal is sent by a respective satellite 112-116 and a time that the GPS signal was received by the GPS receiver of the vehicle 102. The time difference is then used by the vehicle 102 to compute a distance, or range, from its GPS receiver to the respective satellite 112-116. Thereafter, the vehicle 102 computes its own two-dimensional or three-dimensional position using the computed ranges to the satellites 112-116 and a location of the satellites 112-116 when the GPS signals were sent therefrom. The multi-dimensional position is defined by GPS data specifying a direction, a latitude, a longitude, an altitude and/or a velocity.

Methods for determining updated position estimates for vehicle 102 based on GPS data or any other location based data are well known in the art, and therefore will not be described in detail herein. Any such known method for determining updated location estimates may be used with the present invention without limitation.

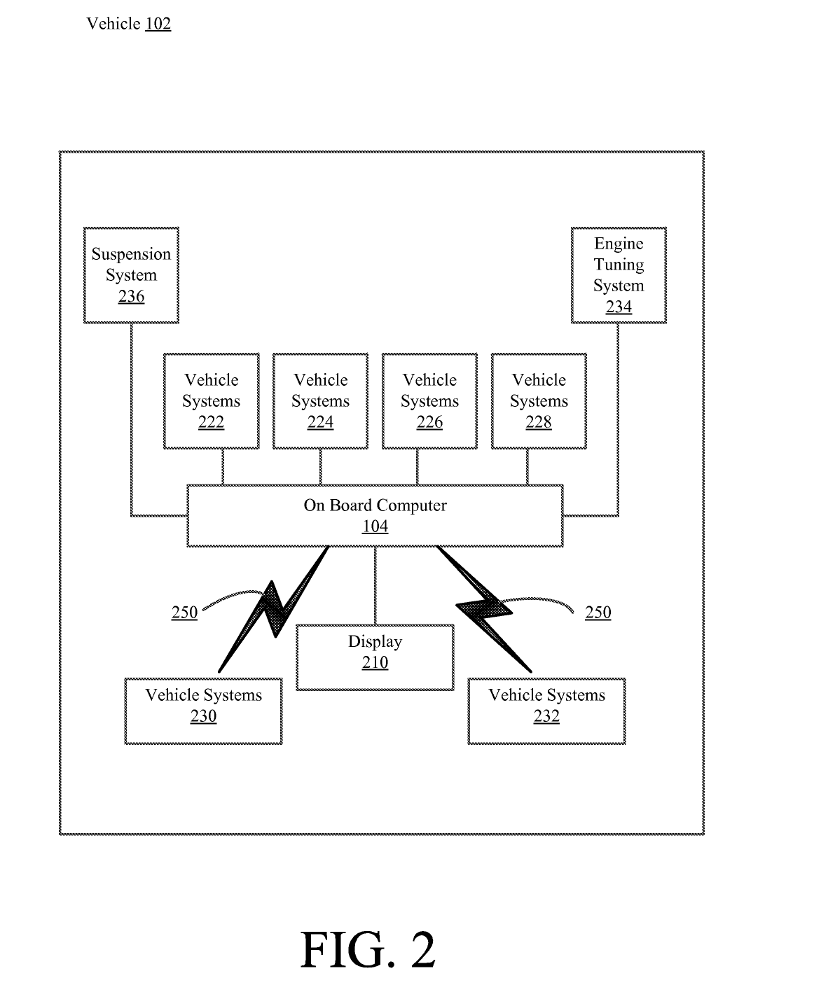

Referring now to FIG. 2, there is provided a more detailed block diagram of the vehicle 102. The vehicle 102 will be described herein as including an onboard computer 104.

Notably, the vehicle 102 may include more or less components than those shown in FIG. 2. For example, the vehicle 102 may include a wired system interface, such as a USB interface (not depicted) to connect the onboard computer 104 with vehicle systems 222-236. However, the components shown are sufficient to disclose an illustrative embodiment implementing the present invention. The hardware architecture of FIG. 2 represents one embodiment of a representative vehicle configured to monitor the fuel/energy efficiency of vehicle 102. In this regard, the vehicle of FIG. 2 implements a method for monitoring and reporting fuel/energy efficiency. Exemplary embodiments of said method will be described below in relation to FIGS. 5-6.

As shown in FIG. 2, the vehicle 102 includes onboard computer 104, which controls various systems within vehicle 102. Onboard computer 104 is also preferably controllably connected to vehicle systems 222-236. These systems may include, but are not limited to, engine tuning systems 234, suspension systems 236, GPS/navigation systems, exhaust systems, heating and ventilation systems, audio and video systems, and the like. Vehicle systems 222-236 may be connected through a wired connection, as shown in FIG. 2, or by other means. For example, vehicle systems 230 and 232 may be connected to the onboard computer 104 by a wireless connection 250 such as 802.11 WiFi or Bluetooth. In one implementation, the onboard computer 104 may be connected to a sensor monitoring the rate of fuel/energy consumption and/or the distance traveled by vehicle 102. The onboard computer may use this information to calculate current fuel/energy efficiency in miles per gallon (“MPG”), or the like. The calculation of the current fuel/energy efficiency may include numerous other factors and the implementations of the present invention are not limited in this regard.

In an implementation, sensors connected to a fuel injection system of vehicle 102 may precisely measure an air mass flow rate during the operation of the vehicle. The air mass flow rate may be determined by any sensing means, including but not limited to, a mass air flow sensor, a manifold absolute pressure sensor, and/or in combination with other sensors. The air mass flow rate is then used by the vehicle's engine control unit (“ECU”) to determine the amount of fuel required to maintain a proper air-to-fuel ratio. Methods of determining an air-to-fuel ratio are well known in the art and may be used in implementations without limitation. These measurements may be combined with other sensor readings of vehicle speed to accurately measure a current fuel efficiency of the vehicle 102's engine. For example, the mass air flow sensor may output a signal that corresponds to an amount of fuel consumed in units of grams per second which may be converted to express the fuel consumption in units of gallons per hour. A vehicle speed sensor may measure the vehicle speed in units of miles per hour. Dividing the vehicle speed in miles per hour by the fuel consumption in gallons per hour then yields an instantaneous actual fuel efficiency expressed in units of MPG.

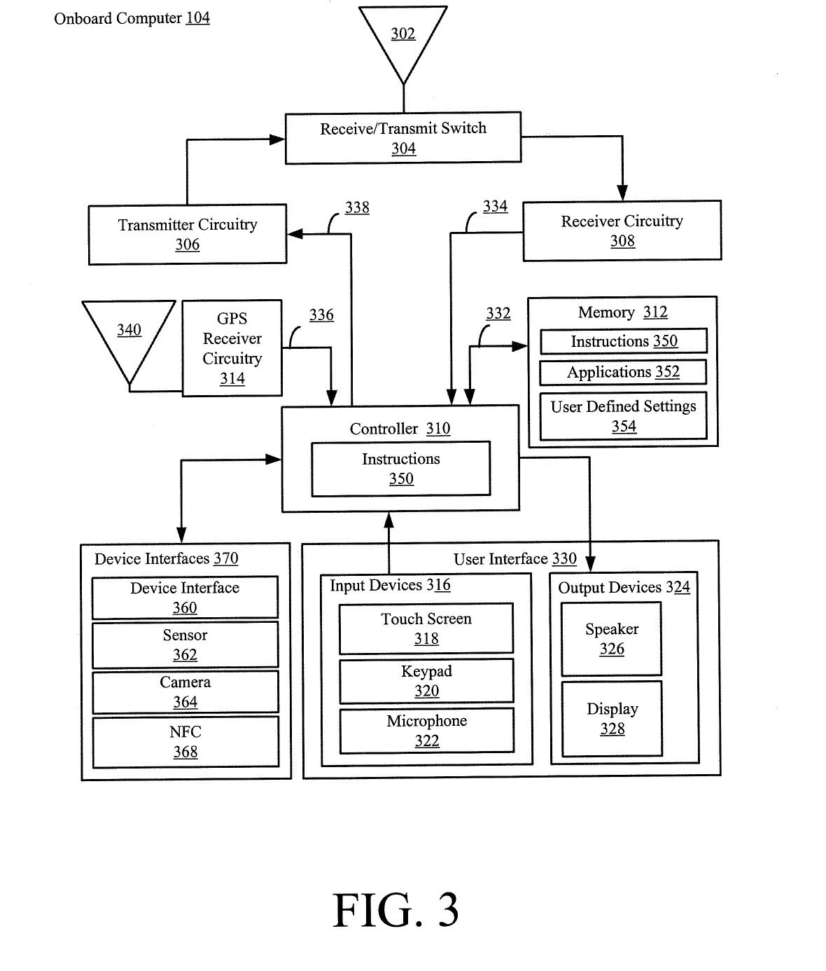

Referring now to FIG. 3, there is a more detailed block diagram of the onboard computer. The onboard computer 104 will be described herein may be a incorporated in a vehicle's radio or stereo system, i.e. the vehicle's “head unit.” The functionality of the onboard computer described herein may be integrated into the head unit, but also may be implemented in a separate piece of hardware which may or may not be electronically connected to the existing head unit. The disclosed embodiments are not limited in this regard. For example, the onboard computer 104 may alternatively comprise a notebook, a laptop computer, a PDA, a tablet computer, a portable navigation device, or other device, and may be located anywhere within vehicle 102.

Notably, the onboard computer 104 may include more or less components than those shown in FIG. 3. For example, the onboard computer 104 may include a wired system interface, such as a universal serial bus interface (not depicted). However, the components shown are sufficient to disclose an illustrative embodiment. The hardware architecture of FIG. 3 represents one embodiment of a representative communication device configured to facilitate the monitoring of the fuel/energy efficiency of vehicle 102. In this regard, the onboard computer of FIG. 3 implements methods of monitoring and reporting fuel/energy efficiency. Exemplary embodiments of said methods will be described below in relation to FIGS. 5-6.

As shown in FIG. 3, a receive/transmit (Rx/Tx) switch 304 selectively couples the antenna 302 to the transmitter circuitry 306 and receiver circuitry 308 in a manner familiar to those skilled in the art. The receiver circuitry 308 demodulates and decodes the RF signals received from any components connected to the onboard computer 104 through a wireless connection (e.g. wireless connection 250 of FIG. 2). The receiver circuitry 308 is coupled to a controller 310 via an electrical connection 334. The receiver circuitry 308 provides the decoded RF signal information to the controller 310. The controller 310 uses the decoded RF signal information in accordance with the function(s) of the onboard computer 104. The controller 310 also provides information to the transmitter circuitry 306 for encoding and modulating information into RF signals. Accordingly, the controller 310 is coupled to the transmitter circuitry 306 via an electrical connection 338. The transmitter circuitry 306 communicates the RF signals to the antenna 302 for transmission to an external device (e.g., network equipment of network 104 of FIG. 1).

An antenna 340 is coupled to GPS receiver circuitry 314 for receiving GPS signals. The GPS receiver circuitry 314 demodulates and decodes the GPS signals to extract GPS location information therefrom. The GPS location information indicates the location of the vehicle 102. The GPS receiver circuitry 314 provides the decoded GPS location information to the controller 310. As such, the GPS receiver circuitry 314 is coupled to the controller 310 via an electrical connection 336. Notably, the present invention is not limited to GPS based methods for determining a location of the vehicle 102. Other methods for determining a location of a communication device may be used with the present invention without limitation.

The controller 310 uses the decoded GPS location information in accordance with the function(s) of the onboard computer 104. For example, the GPS location information and/or other location information may be used to generate a geographic map showing the location of the vehicle 102. The GPS location information and/or other location information may further be used to determine the route the vehicle 102 is traveling.

The controller 310 stores the decoded RF signal information and the decoded GPS location information in a memory 312 of the onboard computer 104. Accordingly, the memory 312 is connected to and accessible by the controller 310 through an electrical connection 332. The memory 312 may be a volatile memory and/or a non-volatile memory. For example, the memory 312 may include, but is not limited to, a Random Access Memory (RAM), a Dynamic Random Access Memory (DRAM), a Static Random Access Memory (SRAM), Read-Only Memory (ROM) and flash memory. The memory 312 may also have stored therein the software applications 352 and user-defined settings 354.

The software applications 352 include, but are not limited to, applications operative to monitor various diagnostic sensors within the vehicle 102. At least one of the software applications 352 is operative to monitor and report fuel/energy efficiency through processing of sensor, location, and other data to determine a current and estimated fuel/energy efficiency. At least one of the software applications 352 is also operative to transmit and/or receive various information to/from server 108.

The user-defined settings 354 comprise statements that define or constrain some operations of the vehicle 102 and/or the onboard computer 104.

As shown in FIG. 3, one or more sets of instructions 350 are stored in the memory 312. The instructions 350 may also reside, completely or at least partially, within the controller 310 during execution thereof by the onboard computer 104. In this regard, the memory 312 and the controller 310 may constitute machine-readable media. The term “machine-readable media”, as used here, refers to a single medium or multiple media that store the one or more sets of instructions 350. The term “machine-readable media”, as used here, also refers to any medium that is capable of storing, encoding or carrying the set of instructions 350 for execution by the onboard computer 104 and that cause the onboard computer 104 to perform one or more of the methodologies of the present disclosure.

The controller 310 is also connected to a user interface 330. The user interface 330 is comprised of input devices 316, output devices 324, and software routines (not shown in FIG. 3) configured to allow a user to interact with and control software applications 352 installed on the onboard computer 104. Such input and output devices respectively include, but are not limited to, a display 328, a speaker 326, a keypad 320, a directional pad (not shown in FIG. 3), a directional knob (not shown in FIG. 3), a microphone 322, a touch screen 318, and the like.

The microphone 322 facilitates the capturing of sound (e.g. voice commands) and converting the captured sound into electrical signals. The electrical signals may be used by the onboard computer 104 to interface with various applications 352.

Device interfaces 370 include various interfaces that allow the onboard computer 104 to interact with other devices and/or the environment in the vehicle 102. Device interfaces include a generic device interface 360 which may be any device interface including, but not limited to, a hardware interface, e.g. USB and IEEE 1394 variants, sensors 362, a camera 364 and a Radio Frequency Identification (RFID) reader or near field communication (NFC) transceiver 368, and the like. Embodiments of the present invention are not limited in this regard.

The sensors 362 may include, but are not limited to, fuel/energy level and consumption sensors, motion sensors, an accelerometer, an altimeter, tire pressure sensors, a velocity sensor and/or a gyroscope, and the like. Accelerometers, fuel/energy use and consumption, motion sensors, altimeters, velocity sensors and gyroscopes are well known in the art, and therefore will not be described herein. However, it should be understood that the sensor data generated by the sensors 362 may be used by the onboard computer 104 to determine a current and expected fuel/energy efficiency.

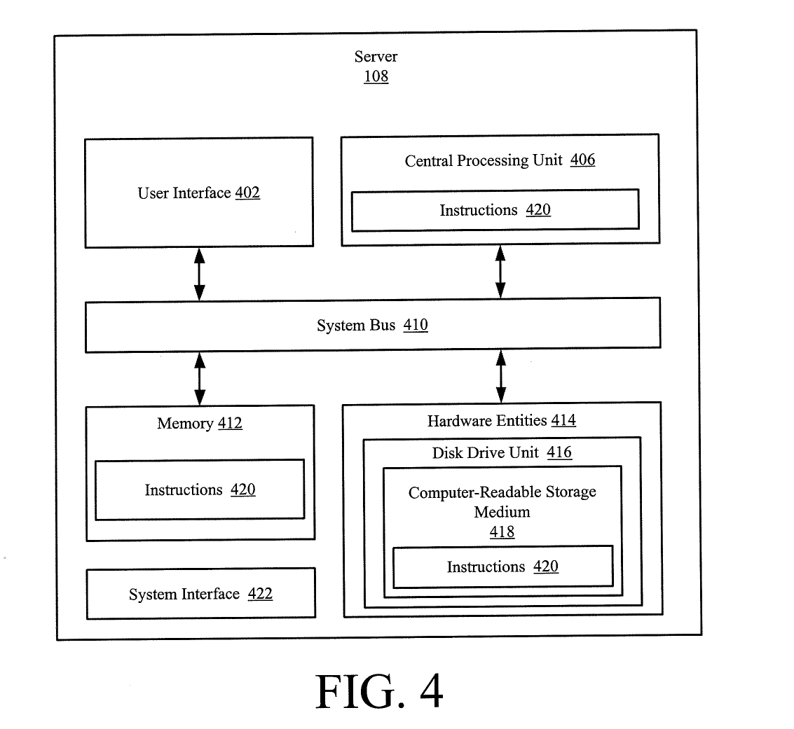

Referring now to FIG. 4, there is provided a more detailed block diagram of the server 108 of FIG. 1 that is useful for understanding the present invention. As shown in FIG. 4, the server 108 comprises a system interface 422, a user interface 402, a Central Processing Unit (CPU) 406, a system bus 410, a memory 412 connected to and accessible by other portions of server 108 through system bus 410, and hardware entities 414 connected to system bus 410. At least some of the hardware entities 414 perform actions involving access to and use of memory 312, which may be a Random Access Memory (RAM), a disk driver and/or a Compact Disc Read Only Memory (CD-ROM). Some or all of the listed components 402-422 may be implemented as hardware, software and/or a combination of hardware and software. The hardware includes, but is not limited to, an electronic circuit.

The server 108 may include more, less, or different components than those illustrated in FIG. 4. However, the components shown are sufficient to disclose an illustrative embodiment implementing the present invention. The hardware architecture of FIG. 4 represents one embodiment of a representative server configured to facilitate the monitoring of fuel/energy efficiency by a communication device (e.g., onboard computer 104 of FIG. 1). As such, the server 108 implements a method for processing and aggregating fuel/energy efficiency information from a plurality of vehicles as well as providing vehicles with information based on the aggregated fuel/energy efficiency. Exemplary embodiments of said method will be described below in relation to FIG. 6.

Hardware entities 414 may include microprocessors, Application Specific Integrated Circuits (ASICs) and other hardware. Hardware entities 414 may include a microprocessor configured to provide an electronic circuit for facilitating the provision of the algorithm and navigation updating services to a user of the communication device (e.g., onboard computer 104 of FIG. 1). In this regard, it should be understood that the microprocessor may access and run various software applications (not shown in FIG. 4) installed on the server 108. Such software applications include, but are not limited to, fuel/energy efficiency analysis, mapping software, and the like. The fuel/energy efficiency analysis and processing applications are operative to facilitate the processing and aggregation of the fuel/energy efficiencies and other information transmitted to server 108 from a communication device (e.g., onboard computer 104 of FIG. 1). The mapping software applications (not shown in FIG. 4) are operative to facilitate the provision of updated maps and navigation routes to a communication device (e.g., onboard computer 104 of FIG. 1) that take into account the current and estimated fuel/energy efficiency received from the plurality of vehicles.

As shown in FIG. 4, the hardware entities 414 may include a disk drive unit 416 comprising a computer-readable storage medium 418 on which is stored one or more sets of instructions 420 (e.g., software code or code sections) configured to implement one or more of the methodologies, procedures, or functions described herein. The instructions 420 may also reside, completely or at least partially, within the memory 412 and/or within the CPU 406 during execution thereof by the server 108. The memory 412 and the CPU 406 also may constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding or carrying a set of instructions 420 for execution by the server 108 and that cause the server 108 to perform any one or more of the methodologies of the present disclosure.

System interface 422 allows the server 108 to communicate directly or indirectly with external communication devices (e.g., onboard computer 104 of FIG. 1). If the server 108 is communicating indirectly with the external communication device, then the server 108 is sending and receiving communications through a common network (e.g., network 104 of FIG. 1).

As noted above, the system 100 implements methods for monitoring, reporting, processing, and analyzing road quality information. Exemplary embodiments of such methods will now be described in relation to FIGS. 5-6.

### Exemplary Methods

Referring now to FIG. 5, there is provided a flow diagram of an exemplary method 500 for monitoring and reporting fuel/energy efficiency. The method 500 will be described in an automotive computing context. The present invention is not limited in this regard. The method 500 is useful in other applications, such as mobile phone and smart phone applications, portable computer applications, PDA applications, portable navigation device applications, and any other application in which monitoring and reporting of fuel/energy efficiency is desired. The method 500 will also be described in a GPS based context. The method 500 is also not limited in this regard. The method 500 is useful in other location based applications, such as reference coordinate system based location applications, topographical survey based location applications, local microwave/sonar beacon/receiver based location applications, ultrasound ranging based location applications, laser ranging based location applications, and/or triangulation based location applications. Further, the method 500 will be described in reference to an electronic circuit, which may be present in any device capable of running any of the above mentioned applications.

In order to protect the privacy of the vehicle owner, monitoring of vehicle location is employed with the owner's consent.

As shown in FIG. 5, the method 500 begins with step 502 and continues with step 504. In step 504, an electronic circuit determines a route of a vehicle 102. In an implementation, the onboard computer 104, which includes the electronic circuit, computes a route of the vehicle 102 using GPS signals that provide a location estimate of the vehicle at various times. The location estimate specifies an estimated geographic location of the vehicle 102 relative to Earth's surface. The estimated position may be a multidimensional estimated location, such as a two dimensional or three dimensional estimated location. Methods for computing position estimates using GPS signals are well known in the art, and therefore will not be described here. Any such method may be used in step 504 without limitation.

In an implementation, the route may be determined by the onboard computer 104 by determining the location of the vehicle 102 at multiple times and matching the movement of the vehicle to a particular route. For example, the onboard computer 104 determines the location of vehicle 102 at time 1, time 2, and time 3. The onboard computer 104 may then compare the locations at those times to a digital map accessible by the onboard computer 104. The onboard computer may determine that road A corresponds to the same locations of vehicle 102 at times 1, 2, and 3. Therefore, the onboard computer may determine that the vehicle 102 was traveling on road A. In another implementation, the route may be determined by driver input into navigation software of the onboard computer 104. In typical navigation applications, the only data input required is a destination location. The navigation software may then determine a route from the current location of the vehicle 102 to the destination location entered by the driver. The determination of the route may be based on a number of factors including, but not limited to, distance, travel time, fuel/energy consumption, cost, and the like. Note that the route may be the route the vehicle has traveled in the past, the route the vehicle is expected to travel in the future, or a combination of both. The implementations of the present invention are not limited in this regard.

Upon completing step 504, step 506 is performed where the electronic circuit monitors at least one sensor signal that corresponds to a current fuel/energy efficiency indication. The sensor signal may be generated by any sensor that monitors vehicle systems relevant to a determination of fuel/energy efficiency including, but not limited to, a fuel/energy gauge, an odometer, a trip meter, a fuel/energy efficiency gauge, a mass air flow sensor, a manifold absolute pressure sensor, an oxygen sensor, a throttle position sensor, a crankshaft position sensor, and/or a Hall effect sensor. In an implementation, the onboard computer 104 may monitor air flow with a mass air flow sensor and the vehicle speed with a wheel speed sensor to derive the miles per gallon. Alternatively, the onboard computer 104 may acquire the air flow from a manifold absolute pressure sensor, the engine speed from crankshaft position sensor or a Hall effect sensor, and an absolute air temperature from a temperature sensor to derive the air flow. One skilled in the art will recognize that a current fuel/energy efficiency indication may be determined instantaneously or continuously. By continuously measuring the distance travelled and the amount of fuel/energy consumed, a current fuel/energy efficiency indication may be continuously refined. Regardless of where the sensor signal is generated, the data may then be used by the onboard computer 104 to determine the expected fuel/energy efficiency of the vehicle 102 as discussed in reference to step 508 below.

Upon completing step 506, step 508 is performed where the electronic circuit generates an expected fuel/energy efficiency indication of the vehicle 102 based on the sensor signal monitored in step 506. This determination may take into account a number of factors. For example, since fuel/energy consumption is inversely proportional to air flow in a typical range of values, an engine running at a higher altitude requires more fuel/energy to operate at the same output level due to the lower air pressure. In an implementation, the onboard computer may analyze the expected route for the vehicle for altitude changes and may accordingly alter an expected fuel/energy use amount. Once an overall fuel/energy use rate is determined, the generation of an expected fuel/energy efficiency indication in terms of MPG may be determined. One skilled in the art will note that the expected fuel/energy efficiency indication may be determined on a continuous, intermittent, simultaneous, or asynchronous basis.

Upon completing step 508, step 510 is performed where the electronic circuit compares the current fuel/energy efficiency indication monitored in step 506 to the estimated fuel/energy indication efficiency determined in step 508. This comparison may be a simple comparison of values. Alternatively, it may be a more sophisticated comparison involving an algorithm designed to detect problems with the local sensors located in vehicle 102. In an implementation, the onboard computer 104 may conduct a comparison of the current fuel/energy efficiency indication and the expected fuel/energy efficiency and determine that a loss of fuel/energy efficiency has occurred. Other sensor information may be monitored by the onboard computer 104. For example, if the fuel/energy efficiency loss occurs simultaneously with a loss of tire pressure, the onboard computer may determine that the fuel/energy efficiency loss is due to under-inflated tires. The onboard computer may then indicate a problem as discussed in relation to step 512.

Upon completing step 510, step 512 is performed where the electronic circuit analyzes the comparison conducted in step 510 to determine if the difference between current fuel/energy efficiency indication and the expected fuel/energy efficiency indication is more than a predetermined amount. If the difference is more than a predetermined amount, the onboard computer 104 indicates a potential problem with the at least one sensor signal. In an implementation, the indication may be a visual and/or audio warning on the display of the onboard computer 104, shown in FIG. 3 as display 328. The indication may be of a sensor problem, a tire inflation problem, a problem with the onboard computer 104, and the like. Note that the indication may be that there is a loss of fuel/energy efficiency without noting a potential cause. For example, if a bicycle is attached to the vehicle such that the aerodynamics of the vehicle are adversely affected, the indication may inform the driver of a lost of expected fuel/energy efficiency due to an unknown cause. The predetermined amount may be set by the manufacturer or may be dynamically determined through the algorithms processed on the onboard computer 104 and/or server 108 through information updates.

Referring again to FIG. 5, the method 500 continues with step 514 where the electronic circuit transmits the route of the vehicle 102, the current fuel/energy efficiency indication, and the expected fuel/energy efficiency indication to a server, e.g. server 108 of FIG. 1. In an implementation, the onboard computer compiles a report including, among other information, the route of the vehicle 102, the current fuel/energy efficiency indication, and the expected fuel/energy efficiency indication. Additionally, rather than a route of vehicle 102, location data (e.g., GPS or other coordinates) could be transmitted for the server to determine the route. The onboard computer 104, through transmitter circuitry 306 and antenna 302 shown in FIG. 3, transmits the report to server 108 through network 106, shown in FIG. 1. The report may include, but is not limited to, the geographic location of the vehicle 102, the route vehicle 102 is currently traveling, expected fuel/energy efficiency indication determined in step 508, the raw sensor data and current fuel/energy efficiency indication monitored in step 506, the make and model of the vehicle 102, and the like.

Upon completing step 514, step 516 is performed where the electronic circuit receives information updates (e.g., from a server such as server 108 of FIG. 1) that include average fuel/energy efficiency indicia based on a plurality of fuel/energy efficiency indications from a plurality of vehicles. In an implementation, the information updates contain averaged road quality indicia supplied from a table or database located on server 108. The onboard computer 104 may use this information to update the local mapping software with the latest road quality updates. Additionally, the information updates may contain updated algorithms (e.g. the algorithm used in step 508, above) that allow for the generation of more accurate fuel/energy efficiency indications. The generation of the information updates is discussed in further detail in reference to FIG. 6 below.

Upon completing step 516, step 518 is performed where the method 500 ends or other processing is performed.

Referring now to FIG. 6, there is provided a flow diagram of a second exemplary method 600 for receiving and processing reported fuel/energy efficiencies for use in a server. The method 600 will be described in an automotive computing context and using GPS-based location information, but. method 600 is not limited in either regard.

As shown in FIG. 6, the method 600 begins with step 602 and continues with step 604. In step 604, an electronic circuit (e.g. at server 108) receives a report from at least one vehicle. The report contains information that may be used by the server to provide enhanced mapping and navigation features to applications running on the onboard computer 104. The report may include, but is not limited to, an estimated fuel/energy efficiency indication, a current fuel/energy efficiency indication, a route of the vehicle 102, sensor data such as that monitored in step 506, the make and model of vehicle 102, and the like.

Upon completing step 604, the method moves to step 606 where the electronic circuit, such as the electronic circuit within the server 108, obtains a route of a vehicle 102, an estimated fuel/energy efficiency indication, and a current fuel/energy efficiency indication. In an implementation, the geographic road location and the road quality indication is obtained through a report transmitted from an onboard computer 104 in vehicle 102 and received by the server 108. As noted above, rather than a route of vehicle 102, location data (e.g., GPS or other coordinates) could be transmitted for the server to determine the route.

Upon completing step 606, step 608 is performed where the electronic circuit updates an algorithm correlating the route, the current fuel/energy efficiency, and the expected fuel/energy efficiency. In an implementation, the server 108 obtains reports from a plurality of vehicles and populates a table or database with the date provided in the reports. As indicated above, these reports may include but are not limited to the geographic location of the reporting vehicle, the route the reporting vehicle is currently traveling, the expected fuel/energy efficiency indication and the current fuel/energy efficiency indication as determined by the reporting vehicle, the raw sensor data monitored by the reporting vehicle, the make and model of the reporting vehicle, and the like. This data is then populated into a table or database that includes at least a table correlating the geographic road location and the road quality indication reported by the vehicles.

In an implementation, the server 108 may also include one or more processing algorithms for analyzing the information contained in the reports. For example, the server 108 may apply an algorithm that determines an average fuel/energy consumption and then discards reports that exhibit more than a predetermined deviation from the average. In an implementation, an algorithm may be included that processes the information to provide fuel/energy consumption based updates for the route traveled. In another implementation, the server 108 may apply an algorithm that determines the impact of a route to the total cost of ownership of the vehicle. The server 108 may also use data received by the server from other sources, including but not limited to, a map database, an vehicle database, and any other database containing publically available information. The implementations of the present invention are not limited in this regard.

Upon completing step 608, step 610 and/or 612 are performed where the electronic circuit generates a revised navigation route for the vehicle 102 that minimizes fuel consumption and/or fuel cost. For example, a driver may wish to travel a route that consumes the least amount of fuel/energy. The server 108 may combine the information about the routes between the current location of the vehicle 102 and the destination with the information in the report about the vehicle 102's fuel/energy efficiency to map out the route that consumes the least fuel/energy. Alternatively, the server 108 may also include publicly available information, gas prices for example, to map out the route which will cost the least to the driver of the car. For example, the onboard computer 104 may read sensors to determine a fuel/energy efficiency and an amount of fuel left in the tank or energy left in an energy storage. The onboard computer 104 may also have access to a public database of gasoline prices indexed to a digital map. The onboard computer may use this information to determine a route to a destination that will yield the lowest cost. The term “cost” includes the route's impact on the total cost of ownership and the amount of time the route adds to the total trip time compared to alternative routes. For example, a user-defined cost may include the route that generates the lowest impact on fuel/energy consumption that adds no more than 10 minutes to the overall trip. Alternatively, another user-defined cost may include the route that has the lowest gas price while adding no more than 10 minutes to the overall trip. Alternatively, another user-defined cost may include the route that has the lowest impact on the total cost of ownership of the vehicle.

Upon completing step 610 and/or 612, step 614 is performed where the electronic circuit provides, in response to a query, information updates based on at least one of the average fuel/energy efficiency indicia, the obtained current fuel/energy efficiency indication for the vehicle, and the obtained expected fuel/energy efficiency indicate for the vehicle. In an implementation, the information updates may be provided to a vehicle 102 requesting the information update via network 106 as shown on FIG. 1. The information update may include, but is not limited to, average fuel/energy efficiency indicia of the route the vehicle 102 is traveling, updated fuel/energy efficiency indication algorithms that allow for more accurate generation of future fuel/energy efficiency indications by the onboard computer of vehicle 102; updated maps and navigation routes, and the like. In an implementation, the information update is generated by server 108 based on the information reports received from multiple vehicles in step 604. Alternatively, the information update may be generated by server 108 using only the information report from vehicle 102, along with other publically available information including, but not limited to, map information, vehicle manufacturer information, and the like.

The method 600 then continues to step 616 where method 600 ends or other processing is performed.

In various implementations, the methods described above may be implemented in systems and devices which include non-transient computer-readable media. Such systems may include at least one electronic circuit configured to perform the methods described above. Devices which include non-transient computer readable media may also include computer programs having a number of code sections. These code sections may be executable by a computer to cause the computer to perform the methods described above.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

1-23. (canceled)

24. A method for generating a route for navigating a vehicle, the method comprising:
obtaining, by an electronic circuit for a plurality of vehicles, indications of (i) a respective route traveled, (ii) a detected fuel/energy efficiency over the route traveled, and (iii) an expected fuel/energy efficiency for the route traveled;
executing, by the electronic circuit, an algorithm for generating fuel/energy efficiency indications using at least the indications (i), (ii), and (iii);
receiving, by the electronic circuit from a vehicle, a request for a route from a first location to a second location;
generating, by the electronic circuit, a navigation route for travelling from the first location to the second location using the generated fuel/energy efficiency indications, wherein the generated navigation route consumes the least fuel/energy of a plurality of routes between the first location to the second location; and
transmitting, by the electronic circuit, to the vehicle, the generated navigation route to the vehicle.

25. The method of claim 24, wherein obtaining the indications of the expected fuel/energy efficiency includes determining, by the electronic circuit, the expected fuel/energy efficiency according to the make and model of the corresponding vehicle.

26. The method of claim 24, wherein obtaining the indications of the expected fuel/energy efficiency includes determining, by the electronic circuit, the expected fuel/energy efficiency based on average fuel/energy efficiency data collected from the vehicle.

27. The method of claim 24, further comprising:
continuously monitoring, by the electronic circuit, the location of the vehicle using a global positioning system (GPS).

28. The method of claim 24, wherein:
obtaining the indications of the detected fuel/energy efficiency includes receiving, by the electronic circuit, the indications of the detected fuel/energy efficiency from the plurality of vehicles.

29. The method of claim 28, wherein:
executing the algorithm includes averaging, by the electronic circuit, the indications of the detected fuel/energy efficiency.

30. The method of claim 24, wherein executing the algorithm includes discarding, by the electronic circuit, some of the indications of detected fuel/energy efficiency indications according to the difference between the detected fuel/energy efficiencies and the corresponding expected fuel/energy efficiencies.

31. The method of claim 29, further comprising:
providing, by the electronic circuit in response to a query, information updates that include the updated algorithm based on at least one of the average fuel/energy efficiency indicia for the route, the obtained current fuel/energy efficiency indications, and the obtained expected fuel/energy efficiency indications.
